(19) United States
(12) Patent Application Publication
(10) Pub. No.: US 2012/0318945 A1
(43) Pub. Date: Dec. 20, 2012

(54) REMOTE ACTUATED PIVOTING CLAMP MECHANISM FOR HOT ROLLING MILLS SPLIT GUIDES, INCLUDING COOLING SYSTEM WATER BOXES AND EQUALIZATION TROUGHS

(75) Inventor: Brian Vallimont, Arlington, MA (US)

(73) Assignee: SIEMENS INDUSTRY, INC., Alpharetta, GA (US)

(21) Appl. No.: 13/162,764

(22) Filed: Jun. 17, 2011

(51) Int. Cl. F16B 2/10; F16M 13/02; F16M 13/00

(52) U.S. Cl. 248/316.5; 24/568

(57) ABSTRACT

Rolling mill split box guide nozzle and equalization trough assemblies are retained by a remote actuated clamping mechanism that includes a central pivoting elongated clamp member having an engagement surface proximal one end that engages the clamped object, and a link pivot proximal the other end. A pivoting link has a first end pivotally coupled to the clamp member link pivot and a second end that is pivotally coupled to an actuator shaft. The actuator shaft is capable of translation to a locked position that maintains engagement between the clamp member and the clamped split box nozzle assembly or equalization trough object, wherein the link blocks clamp member motion. The actuator shaft is also capable of translation to an unlocked position that enables clamp member pivoting motion out of engagement with the clamped object. The actuator shaft may be translated by an actuator controlled by a factory automation system.

### BACKGROUND

1. Field

Embodiments of the present invention relate to remote actuated pivoting clamp mechanisms suitable for application in hot rolling mills and more particularly to a clamp mechanism suitable for retaining split box structures, including split guides, that may be used in cooling system water box nozzle assemblies and equalization troughs.

2. Description of the Prior Art

Steel bars and rods are produced by hot rolling steel billets in a continuous hot rolling process. During different steps of the rolling process the rolled products may require motion restraint, so that they follow a designated transport path, temperature equalization or quenching by application of cooling water. After the metal forming steps, the rolled products are conveyed along one or more lines running through sequential split box structures, also known as split guides, that are analogous to tunnels that direct them along desired paths. Water box cooling lines spray the hot rolled product surface with pressurized water. Nozzle assemblies include a plurality of annular-shaped nozzles that are retained within the split shell nozzle assembly boxes. The annular nozzles spray water on the hot metal that is transported through the nozzle annular interiors. Nozzle assemblies and their split shell boxes are sequentially arrayed along the cooling line and are of known construction. The nozzle assemblies are in communication with a pressurized water manifold, and must be held in fixed position to avoid water leaks and potential loss of cooling efficiency if insufficient flow and/or pressure are not maintained at each nozzle due to leaking water diversion. Temperature equalization troughs also transport hot metal rolled products via internal pathways within static guide split shell box structures, but do not apply a cooling fluid. Rather, equalization troughs reduce or minimize further temperature loss from the product surface, thereby allowing heat to “soak” out from the interior; i.e., “equalizing” the temperature between the interior and the exterior of the hot rolled product.

Conventionally, rolling mill line split guide structure water box nozzle assemblies and equalization troughs have been held in fixed position by screw-driven manual “C clamps”, such as shown in U.S. Pat. No. 5,257,511, the entire contents of which is incorporated herein by reference. In order to avoid nozzle leakage and potential loss of cooling efficiency, each individual C clamp is hand tightened by mill personnel to a torque specification. The hand tightening procedure is time consuming, as a cooling line may have hundreds of nozzle assemblies within a facility, and is subject to human error if torque is not in compliance with the specification.

An alternative to nozzle assembly retention by C clamps is disclosed in U.S. Patent Publication No. US 2010/0006188 A1, the entire contents of which are incorporated herein by reference. The Publication discloses use of a remote actuated pivoting clamp support that may be coupled to a plurality of nozzle assemblies for simultaneous clamping of a series of sequential nozzle assemblies along a cooling line. One long lateral side of the clamp support is pivotally engaged with the water box frame that retains the sequence of nozzle assemblies in an array. The other lateral side of the clamp support is linked to a pivoting shaft that is driven by an actuator. When the driven shaft pivots, the other lateral side of the clamp support may be swung from an open to a closed position. Rotating torque force must be maintained on the driven shaft in order to retain the nozzle assembly in the closed or “clamped” position, requiring constant energy consumption and wear and tear on the actuator and entire linkage assembly. The pivoting shaft and linkage does not maintain constant force on each serial nozzle assembly due to deflection variations along the shaft length. Thus a higher than otherwise needed constant force is applied to the shaft assembly by the actuator in order to assure that each individual nozzle assembly meets minimum clamping force specifications. In turn, a larger actuator and pivoting shaft is required to generate and transfer the higher force needed to assure clamping of each nozzle assembly within minimum specification. Larger actuators and shaft structures necessitate greater energy consumption during operation and use of additional material for construction strength. The angular linkage also stresses the water box frame as the actuator exerts clamping force on the nozzle assembly. Therefore, water box frame rigidity needs to be increased in order to counteract the linkage stress, also increasing material consumption during manufacture.

### SUMMARY

Briefly described, embodiments of the present invention relate to the creation of a clamping mechanism that can be remotely actuated, for example without the necessity of hand tightening, and is suitable for application to rolling mills, including their temperature equalization troughs and water box nozzle assemblies.

Another embodiment of the invention relates to a water box nozzle assembly clamping mechanism that remotely actuates a plurality of nozzle assemblies arrayed along a cooling line in parallel, under manual user or automated system control.

An additional embodiment of the present invention relates to a temperature equalization trough split guide assembly clamping mechanism that remotely actuates a plurality of split guides arrayed in a cooling line in parallel, under manual user or automated system control.

Yet another embodiment of the present invention relates to a nozzle assembly clamping mechanism that remotely locks a nozzle assembly in a clamped position and thereafter does not require or reduces requirement for external actuator force to maintain the nozzle assembly in the clamped position. Additionally, it is desirable that the clamping mechanism remotely unlocks itself when it is desired to release the nozzle assembly unit from the water box assembly frame.

Another embodiment of the present invention relates to a nozzle assembly clamping mechanism that does not stress the water box frame while applying and/or maintaining nozzle assembly clamping force.

These and other embodiments are achieved in accordance with the present by a remote actuated clamping mechanism for objects to be clamped in hot rolling mills, including for rolled product motion restraint split guide, equalization trough and cooling system water box nozzle assembly retention. The clamping mechanism includes a central pivoting elongated clamp member having an engagement surface proximal one end that engages the split box nozzle assembly, equalization trough, split guide or other clamped object and a link pivot proximal the other end. The clamp member is pivotally coupled to a structural member that is independent of the water box or equalization trough frame. A pivoting link has a first end pivotally coupled to the clamp member link pivot and a second end that is pivotally coupled to an actuator shaft. The actuator shaft is capable of translation to a locked position that maintains engagement between the clamp member and the clamped object, such as for example a split box nozzle assembly, wherein the link blocks clamp member motion. Actuation force does not have to be maintained on the actuation shaft when the clamp member is in the locked position. The actuator shaft is also capable of translation to an unlocked position that enables clamp member pivoting motion out of engagement with the nozzle assembly or other clamped object. The actuator shaft may be translated by an actuator that is controlled by a factory automation system.

Aspects of the present invention feature a remote actuated pivoting clamp mechanism that includes a structural member having sequentially arrayed thereon a plurality of opposed pairs of pivot points respectively sharing a collinear first pivot axis. A plurality of pairs of elongated clamp members corresponds to each pair of structural member pivot points. Each clamp member has an engagement surface proximal one end, a link pivot proximal the other end, and a central pivot intermediate the ends that is pivotally coupled to a respective one of the structural member pivot points about the first axis. The mechanism also has a plurality of pivoting links respectively corresponding to each pair of clamp members, with each link having a first end pivotally coupled to both of the clamp member pair respective link pivots about a second collinear axis parallel to the first axis, and a second end. An actuator shaft is pivotally coupled to each of the respective link second ends about a third axis parallel to the first axis at each respective pair of opposed pivot points. The shaft is capable of toggled translation of all pivoting links to a locked position wherein each respective pair of the first and third axes are proximal each other and the link blocks clamp member motion. The shaft is also translatable to an unlocked position that enables pivoting motion of each clamp member about its respective first axis.

Aspects of the present invention also feature a remote actuated pivoting clamp mechanism for clamping hot rolling mill guide split boxes. The mechanism features a plurality of sequentially arrayed split boxes, each having opposed halves defining a path there through and a first engagement surface on at least one of the halves. A structural member has aligned with each respective split box a plurality of opposed pairs of pivot points respectively sharing a collinear first pivot axis. Each pivot pair corresponding to a split box is sequentially arrayed on the structural member. A plurality of pairs of elongated clamp members corresponds to each pair of structural member pivot points. Each clamp member has an engagement surface proximal one end for mating engagement with a corresponding first engagement surface, a link pivot proximal the other end, and a central pivot intermediate the ends that is pivotally coupled to a respective one of the structural member pivot points about the first axis. A plurality of pivoting links respectively corresponds to each pair of clamp members. Each link has a first end pivotally coupled to both of the clamp member pair respective link pivots about a second collinear axis parallel to the first axis, and a second end. An actuator shaft is pivotally coupled to each of the respective link second ends about a third axis parallel to the first axis at each respective pair of opposed pivot points. The shaft is capable of toggled translation of all respective pivoting links to a locked position wherein each respective pair of first and third axes are proximal each other. Each link blocks its respective clamp member motion and maintains mating engagement between each respective pair of first and clamp member engagement surfaces. The shaft is also capable of translation of all respective pivoting links to an unlocked position that enables clamp member pivoting motion about its respective first axis and disengagement of each mating pair of first and clamp member engagement surfaces.

Aspects of the present invention additionally feature a method for remotely actuating a pivoting clamp mechanism for clamping hot rolling mill cooling line split boxes. The clamp mechanism used to perform the method has a plurality of sequentially arrayed split boxes, each having opposed halves defining a path there through and a first engagement surface on at least one of the halves. A structural member has aligned with each respective split box a plurality of sequentially arrayed opposed pairs of pivot points respectively sharing a collinear first pivot axis. A plurality of pairs of elongated clamp members corresponds to each pair of structural member pivot points. Each clamp member has an engagement surface proximal one end for mating engagement with a corresponding first engagement surface, a link pivot proximal the other end, and a central pivot intermediate the ends that is pivotally coupled to a respective one of the structural member pivot points about the first axis. A plurality of pivoting links respectively corresponds to each pair of clamp members. Each link has a first end pivotally coupled to both of the clamp member pair respective link pivots about a second collinear axis parallel to the first axis, and a second end. An actuator shaft is pivotally coupled to each of the respective link second ends about a third axis parallel to the first axis at each respective pair of opposed pivot points. The shaft is capable of toggled translation of all respective pivoting links to a locked position wherein each respective pair of first and third axes are proximal each other. In the locked position each link blocks its corresponding respective clamp member motion and maintains mating engagement between each respective pair of first and clamp member engagement surfaces. The shaft is also capable of translation of all respective pivoting links to an unlocked position that enables clamp member pivoting motion about its respective first axis and disengagement of each mating pair of first and clamp member engagement surfaces. An actuator for translating the actuation shaft is coupled thereto. A control system, in communication with the actuator, includes a controller having a processor and memory accessible by the processor. The memory includes therein software that when executed by the processor selectively causes the actuator to translate the actuation shaft. The control system also has an interface coupled to the controller, for issuing commands to translate the actuation shaft. The clamping method is performed by issuing an actuator shaft translation command to the control system with the interface. After receipt of the translation command the processor executes actuator translation software, causing the actuator to translate the actuation shaft to the locked or unlocked positions.

The objects and features of the present invention may be applied jointly or severally in any combination or sub-combination by those skilled in the art.

### BRIEF DESCRIPTION OF THE DRAWINGS

The teachings of aspects of the present invention can be readily understood by considering the following detailed description in conjunction with the accompanying drawings, in which:

FIG. 1 is an elevational perspective view of a hot rolling mill with a nozzle assembly clamping mechanism, in accordance with an exemplary embodiment of the present invention;

FIG. 2 is bottom plan perspective view of FIG. 1, in accordance with an exemplary embodiment of the present invention;

FIG. 3 is a cross-sectional view taken along line 3-3 of FIG. 1, in accordance with an exemplary embodiment of the present invention;

FIG. 4 is a perspective view of a load transfer assembly including a spring assembly, in accordance with an exemplary embodiment of the present invention;

FIG. 5 is a cross-sectional view taken along line 5-5 of FIG. 4, in accordance with an exemplary embodiment of the present invention;

FIG. 6 is an elevational view showing the clamping mechanism in a locked position, in accordance with an exemplary embodiment of the present invention;

FIG. 7 is an elevational view showing the clamping mechanism in an unlocked position, in accordance with an exemplary embodiment of the present invention;

FIG. 8 is an elevational view showing the clamping mechanism in an unlocked position that facilitates removal of a nozzle assembly, in accordance with an exemplary embodiment of the present invention;

FIG. 9 is an elevational view showing the clamping mechanism in an unlocked position, with the clamp member shown in partial broken-away section, in accordance with an exemplary embodiment of the present invention;

FIG. 10 is a schematic diagram of the remote actuation clamping mechanism actuated by an actuator that is controlled within an automated system, in accordance with an exemplary embodiment of the present invention;

FIG. 11 is an alternative embodiment clamping mechanism with an adjustable length pivoting link, in accordance with an exemplary embodiment of the present invention;

FIG. 12 is another alternative embodiment clamping mechanism with a constant force, adjustable length pivoting link, in accordance with an exemplary embodiment of the present invention; and

FIG. 13 is another alternative embodiment clamping mechanism for a temperature equalization trough assembly guide.

To facilitate understanding, identical reference numerals have been used, where possible, to designate identical elements that are common to the figures.

### DETAILED DESCRIPTION

After considering the following description, those skilled in the art will clearly realize that the teachings of my invention can be readily utilized in remote actuated pivoting clamp mechanisms suitable for application in hot rolling mills and more particularly to a clamp mechanism suitable for retaining cooling system nozzle assemblies, as well as other objects to be clamped in a rolling mill, including by way of further example split guides and those used for temperature equalization troughs. Exemplary embodiments of the present invention that are described herein facilitate parallel remote actuation of a plurality of clamp mechanisms that are dedicated to different objects, such as split box static guides, equalization troughs or nozzle assemblies serially arrayed along a hot rolling mill cooling system. Remote actuation can be accomplished under manual or automatic control.

Hot Rolling Mill Cooling System Overview

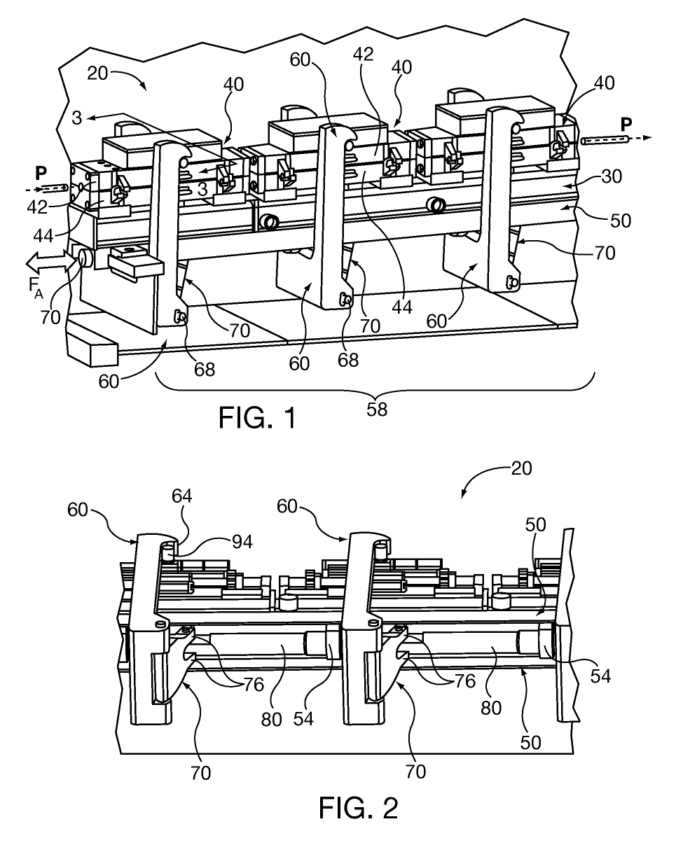

Referring to FIGS. 1-3, hot rolled material is sequentially fed through the rolling mill cooling system 20 along path P. The cooling system 20 has a cooling header 30 that provides cooling water to the nozzle assemblies 40. As shown in the figures, a plurality of nozzle assemblies are sequentially aligned in parallel along the cooling path P. Each nozzle assembly 40 has an upper half 42 and lower half 44, each half retaining sleeve-like annular nozzles 46. The rolled material passes through the annular nozzle 46 sleeves interior portions 48 that are respectively aligned along the cooling path P. The nozzle assemblies 40 are of known construction.

The cooling system 20 has a structural member 50, including a pair of opposed clamping member trunnions 52 that can have a common axial alignment axis. In some embodiments, the structural member 50 can be structurally isolated and independent from the cooling header 30 and nozzle assemblies 40.

Clamping Mechanism Structure

Referring to FIGS. 1-3, the clamping mechanism 58 includes clamp member 60 that has a central pivot 62 that is pivotally coupled to the clamping member trunnion 52. Alternatively, one may choose to configure the clamping mechanism so that the trunnion is formed in the clamp member 60 and the central pivot is formed in the structural member 50. Clamp member 60 also defines an engagement surface 64 on one end and a link pivot aperture 66 for pivotal receipt of link pivot pin 68 on the other end. As shown in FIGS. 1-3, the clamping mechanism 58 has a pair of laterally aligned clamp members having a common central pivot axis through respective central pivots 62. The pair of clamp members 60 provides for a uniform application of clamping force on both sides of the nozzle assembly 40.

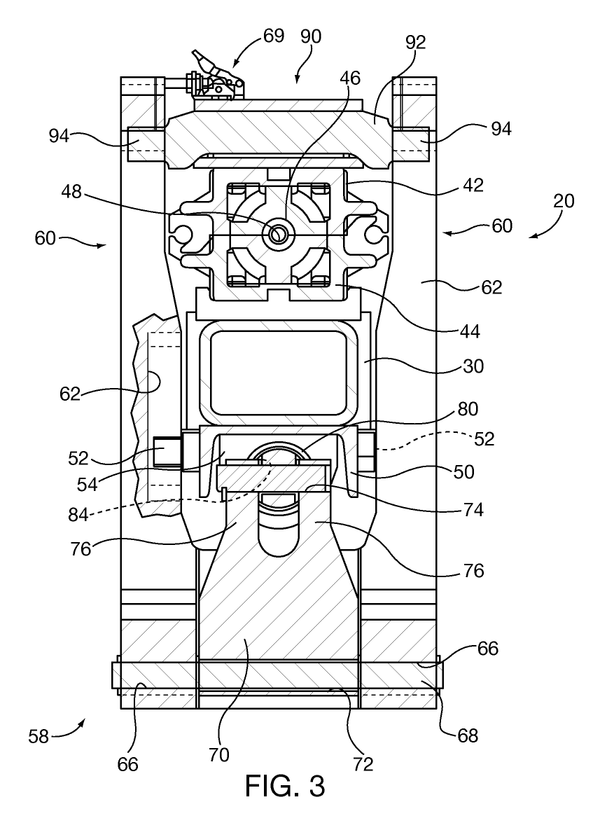

Pivoting link 70 is pivotally coupled to the clamp member 60 by the link pivot pin 68 that passes through the link first end aperture 72. The second end of the pivoting link opposite the first end 72 can define a second end aperture 74. As shown most clearly in FIGS. 2 and 3, the pivoting link 70 has a pair of yoke arms 76, each defining a second aperture 74, for more generally uniform structural support to both of the clamp members 60.

The clamping mechanism 58 also has an actuator shaft 80 defining a plurality of actuator shaft apertures 82, each pivotally coupled to the second end of a corresponding pivoting link 70 by an actuator shaft pin 84 captured within an actuator shaft aperture 82 and pivoting link second end aperture 74. The actuator shaft 80 is captured within actuator shaft supports 54 that are coupled to the structural member 50. As will be explained in greater detail herein when describing operation of the clamping mechanism 58, the actuator can translate in both directions of the double arrow F_{A}.

As shown in FIGS. 1 and 3, load transfer assembly 90 includes a housing 91 having therein a load transfer frame 92 with a pair of opposed load transfer frame first engagement surfaces (trunnions 94) that engage with a clamp member engagement surface 64 on each of the clamp members 60. As shown, the transfer frame trunnions 94 can share a common axis. The corresponding abutting and mating engagement surfaces 64 on the clamp member 60 and 94 on the load transfer assembly 90 may be of many desired profiles, and may be reversed. For example and not limitation, the engagement surface 64 may have a trunnion profile and the load transfer frame first engagement surfaces 94 may have a corresponding concave profile.

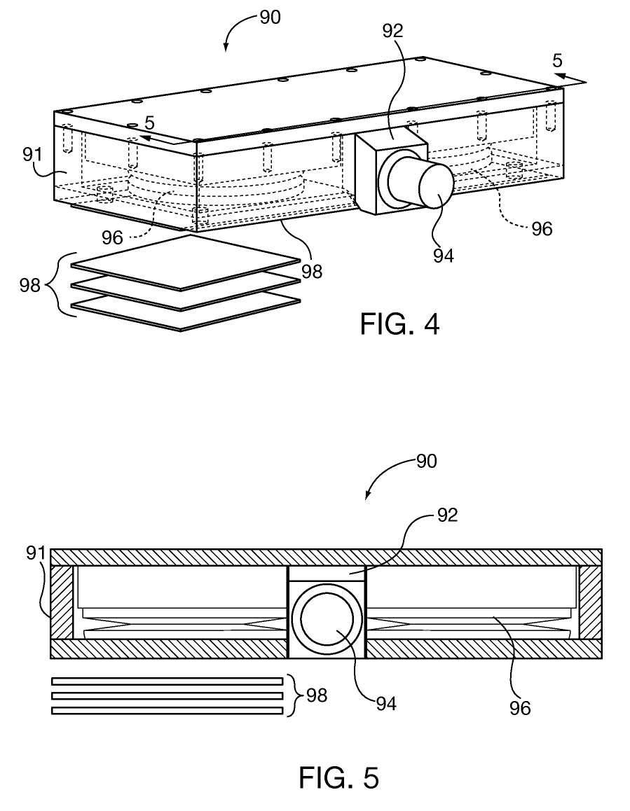

The exemplary load transfer assembly 90 in FIGS. 3-5 comprises a pair of disc or cupped springs 96 and shim stacks 98. The biasing element springs 96 help to distribute equalized compressive force to the nozzle assembly 40 top surface upstream and downstream the trunnions 94, for pressurized water sealing along the lateral joining surface between the upper nozzle assembly 42 and lower nozzle assembly 44 halves, as well as the lower half 44 to the cooling header 30. The springs 96 also help equalize load transferred to each of tandem paired clamp members 60 that flank each nozzle assembly 40 to the left and right of the cooling path P. Shim stacks 98 can be varied to raise or lower the load transfer engagement surface trunnion 94 relative to the clamp member engagement surface 64, thereby increasing or decreasing the load applied to the respective nozzle assembly.

Clamping Mechanism Operation

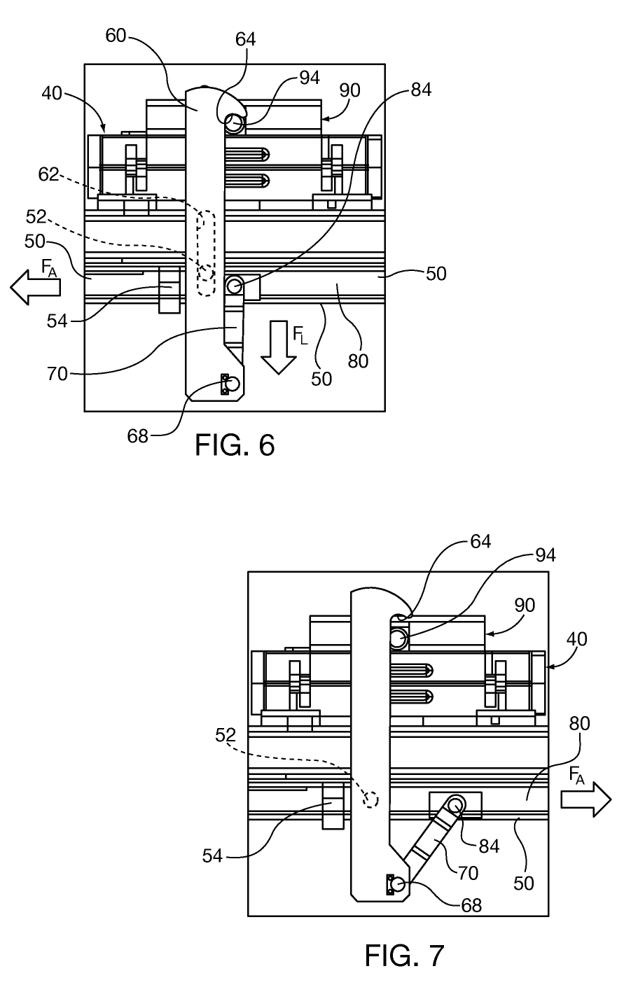

FIGS. 6-9 show general operation of the clamping mechanism 58. In FIG. 6, when the actuator shaft 80 is translated in the direction of the F_{A} force arrow, pivoting link 70 is toggled to a locked (here vertical) position, with the actuator pin rotation axis parallel to and proximal the central pivot axis through the structural member trunnion 52. In the locked position the pivoting link 70 applies a force on the clamping mechanism link pivot aperture 66 via the link pivot pin 68 in the direction of the force arrow F_{L}. The elongated link pivot aperture 66 allows vertical movement of the clamp member 60 as the link 70 is toggled to the locked position, so that the clamp member engagement surface 64 is maintained in biased, abutting relationship with the load transfer assembly first engagement surface trunnion 94. The clamp member central pivot 62 can be constructed without an elongated profile, and the profile can be non-linear to impart a camming motion.

When the pivoting link 70 is toggled to the locked position it may be constructed to be self locking, so that little or no force is maintained on the actuator shaft. While the pivoting link 70 is shown in FIG. 6 to be generally vertical and parallel to the clamp member 60 long axis, it can also be constructed to toggle over center (i.e., further counter clockwise) when in the locked position, such as by changing the center pivot 62 elongation profile.

The locked clamping mechanism 58 clamping force F_{L} is resisted in the opposite direction by the structural member 50 actuator shaft supports 54. The structural member 50 is structurally isolated from and does not pass the clamping force F_{A} to the cooling header 30 or nozzle assembly 40 structures. The clamping force F_{L} is transferred vertically through the load transfer assembly 90, beneficially compressing the nozzle assembly 40 against the cooling header 30 without bending or twisting distortion.

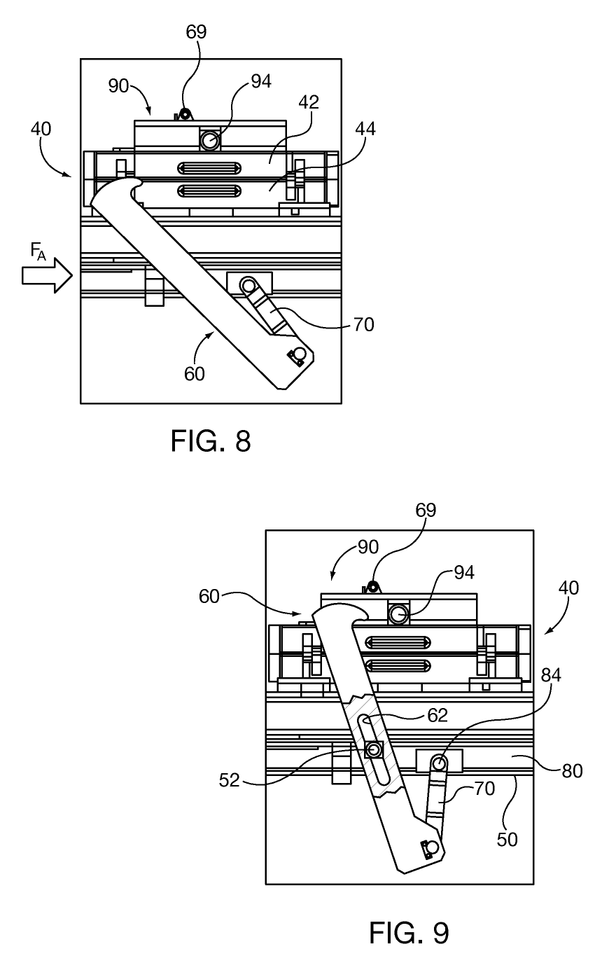

Clamp mechanism can be released to an unlocked position as shown in FIGS. 6-9 by applying actuation force F_{A} to the actuator shaft in the direction shown, so that the pivoting link 70 is no longer toggled with the actuator pin 84 proximal the clamp member central pivot 62. If desired, a clamp lock, such as the toggle clamp 69 shown in FIG. 3, may be provided to prevent inadvertent or unintentional displacement of the clamping mechanism 58 from its vertical unlocked position when the clamp mechanism 58 is unlocked and the opposed engagement surfaces 64/94 are not in contact with each other. In FIG. 8, the clamp member 60 is tilted counterclockwise to enable service technician access to the nozzle assembly 40, by sliding the trunnion 52 within the central pivot elongated slot 62.

Automated Clamping Operation

The clamping mechanism 58 advantageously may be employed to clamp a sequence of nozzle assemblies 40 that are arrayed along a cooling system 20 cooling path P by pivotally coupling in parallel a series of respective pivoting links 70 to a common actuation shaft 80, as is shown in FIGS. 1 and 2. A single actuator, such as a pneumatic or hydraulic fluid driven cylinder or a gear driven motor, may translate the shaft. In this manner a plurality of clamping mechanisms 58 may be actuated simultaneously by a single actuator operation.

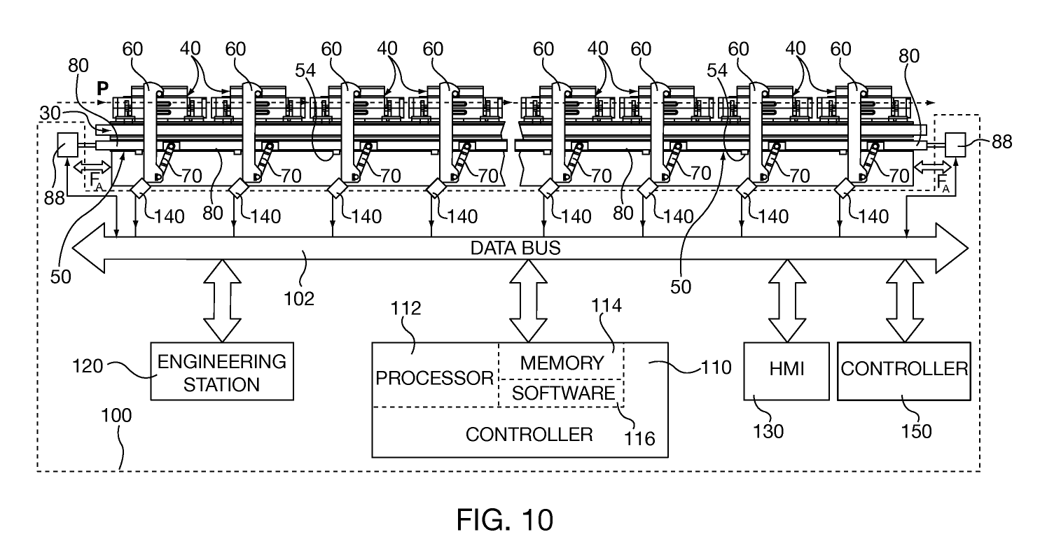

The clamping mechanism is suited for automated clamping and unclamping operations for rolling mill cooling systems 20, such as by the exemplary factory automation system 100 schematically shown in FIG. 10. The automated clamping system 100 includes a communications data bus of known architectural and communications design, such as one employing PROFIBUS® data communications protocols provided by Siemens Industry Solutions of Alpharetta, Ga., U.S.A. A controller 110, such as a programmable logic controller (PLC) is in communication with one or more actuators 88. The PLC 110 is of known design, such as a Siemens model S7 PLC also sold by Siemens Industry Solutions of Alpharetta, Ga., U.S.A. PLC 110 includes a processor 112 that accesses one or more computer memory devices 114, in which are stored software instruction sets 116 that when executed by the processor causes it to operate the automation system 100.

The processor 112 executing the software instruction sets 116 cause one or more actuators 88 to exert an actuation force F_{A} a respectively coupled actuation shaft 80, that in turn locks or unlocks the clamping mechanisms 58. Two separate banks of clamping mechanisms 58 and actuators 88 are shown in FIG. 10 respectively on the left and right sides of the sheet. The PLC 110 causes one or more of the actuators 88 to exert actuation force on its actuator shaft 80 as part of an operational programming sequence within its accessible software 116, or in response to commands received from engineering station 120 or any other human machine interface (HMI) 130. For example, a service technician may initiate a command to the automation system through the HMI 130 to open one or more of the clamping mechanism banks 60. The automation system 100 may include one or more types of sensors 140 to communicate rolling mill cooling system 20 operational parameters to the PLC 110, such as by way of non-limiting example proximity sensors indicating whether one or more clamps are in locked or unlocked position, cooling water pressure or temperature, etc. PLC 110 may also be in communication with one or more other industrial automation controllers as part of an industrial automation network, such as controller 150.

Clamping Mechanism Alternative Embodiments

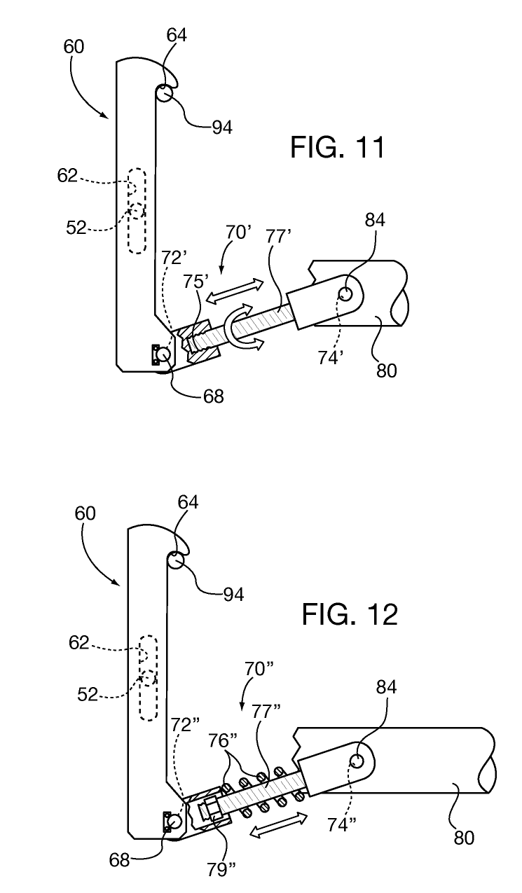

FIGS. 11 and 12 show alternative pivoting link embodiments, for varying spacing between the clamping member 60 engagement surface 64 and the load transfer assembly first engagement surface trunnion 94. In FIG. 11 the pivoting link 70′ defines a first end with aperture 72′and a second end with aperture 74′. Changing distance between the respective apertures 72′, 74′ by advancing or withdrawing the threaded shaft 77′ within the female threaded portion 77′ alters spacing between the engagement surfaces 64, 94. In FIG. 12, the pivoting link 70″ defines a first end with aperture 72″ and a second end with aperture 74″. Helical coil spring 76″ is captured by threaded shaft 77″ and mating nut 79″. The coil spring 76″ provides for constant clamping force between the engagement surfaces 64, 94. Changing distance between the respective apertures 72″, 74″ by advancing or withdrawing the threaded shaft 77″ alters spacing between the engagement surfaces 64, 94.

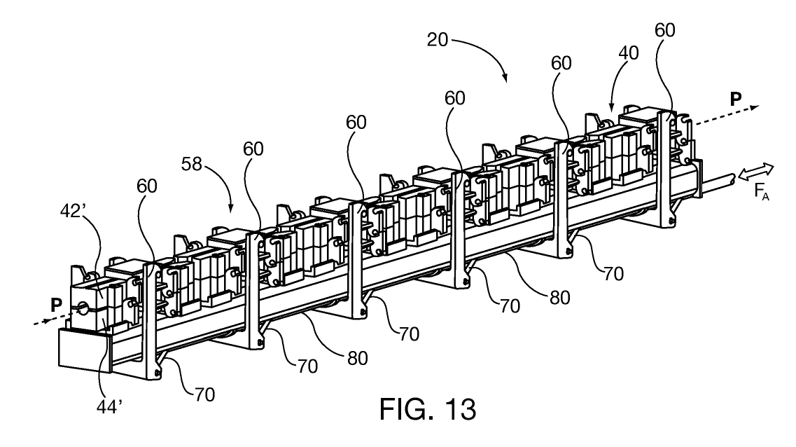

As previously noted, the clamping mechanism may be applied in other assemblies within a rolling mill that require remote clamping in locked positions of one or more objects under common linear actuator control. In FIG. 13 the clamping mechanism 58 is used to apply clamping force to a thermal equalization line 20′ series of thermal equalization troughs 40′ having split box upper and lower halves 42′, 44′.

Although various embodiments which incorporate the teachings of the present invention have been shown and described in detail herein, those skilled in the art can readily devise many other varied embodiments that still incorporate these teachings.

What is claimed is:

1. A remote actuated pivoting clamp mechanism, comprising:
a structural member;
an elongated clamp member comprising an engagement surface proximal one end, a link pivot proximal the other end, and a central pivot intermediate the ends that is pivotally coupled to the structural member about a first axis;
a pivoting link comprising a first end pivotally coupled to the clamp member link pivot about a second axis parallel to the first axis, and a second end; and
an actuator shaft pivotally coupled to the link second end about a third axis parallel to the first axis, the shaft capable of translation to a locked position wherein the first and third axes are proximal each other and the link blocks clamp member motion and an unlocked position that enables clamp member pivoting motion about the first axis.

2. The mechanism of claim 1, wherein the actuator shaft translates along a fourth axis that is perpendicular to and oriented between the first and second axes.

3. The mechanism of claim 1 further comprising a pair of parallel clamp members having collinear first axes and their respective link pivots are coupled to the link.

4. The mechanism of claim 1, wherein the central pivot is elongated, and the clamp member is translatable therein.

5. The mechanism of claim 1, wherein the link has an adjustment mechanism for varying distance between the second and third axes.

6. The mechanism of claim 1, further comprising:
an object to be clamped by the clamp member having an first engagement surface for mating engagement with the clamp member engagement surface; and
a biasing element coupled to the object to be clamped or the clamp member for biasing the respective engagement surfaces into abutting contact with each other.

7. The mechanism of claim 1, further comprising a plurality of clamp members and respective links pivotally coupled in parallel to both of the structural member and a common actuator shaft, the clamp members commonly pivoting between locked and unlocked positions by actuator shaft translation.

8. The mechanism of claim 7, further comprising a remote controlled actuator for translating the actuator shaft in response to translation commands from a controller that is in communication therewith.

9. The mechanism of claim 8, wherein the remote controlled actuator is controlled by an industrial automation system in communication therewith.

10. The mechanism of claim 7, further comprising a plurality of hot rolling mill split box assemblies, each having a first engagement surface paired with a corresponding one of each of the respective clamp members, each of the respective clamp member engagement surfaces engaging its respective first engagement surface when the actuator shaft is in the locked position, and each respectively disengaged from each other when the actuator shaft is in the unlocked position.

11. The mechanism of claim 10, further comprising a load transfer assembly defining the first engagement surface, coupled to each of the respective split box assemblies.

12. The mechanism of claim 11, wherein at least one of the load transfer assemblies has a biasing element interposed between itself and its corresponding split box assembly, for biasing the respective clamp member and first engagement surfaces into abutting contact with each other.

13. The mechanism of claim 11, further comprising a shim interposed between at least one load transfer assembly and its corresponding split box assembly for varying distance between its corresponding clamp member and first engagement surfaces when the corresponding clamp member is engaged in a locked position.

14. The mechanism of claim 11, further comprising a plurality of pairs of elongated clamp members sharing a common pivoting link, wherein each pair is laterally spaced from each other on a collinear first pivot axis and respective pairs have sequentially arrayed parallel first pivot axes.

15. The mechanism of claim 14, further comprising:
an object to be clamped by each respective clamp member pair interposed therebetween, the object having a pair of opposed outwardly projecting first engagement surfaces for mating engagement with a respective clamp member engagement surface.

16. The mechanism of claim 15, wherein the object is a rolling mill split box assembly.

17. The mechanism of claim 16, further comprising a load transfer assembly defining the first engagement surfaces, coupled to each of the respective split box assemblies.

18. A remote actuated pivoting clamp mechanism, comprising:
a structural member having a sequentially arrayed thereon plurality of opposed pairs of pivot points respectively sharing a collinear first pivot axis;
a plurality of pairs of elongated clamp members corresponding to each pair of structural member pivot points, each clamp member having an engagement surface proximal one end, a link pivot proximal the other end, and a central pivot intermediate the ends that is pivotally coupled to a respective one of the structural member pivot points about the first axis;
a plurality of pivoting links respectively corresponding to each pair of clamp members, each link having a first end pivotally coupled to both of the clamp member pair respective link pivots about a second collinear axis parallel to the first axis, and a second end; and
an actuator shaft pivotally coupled to each of the respective link second ends about a third axis parallel to the first axis at each respective pair of opposed pivot points, the shaft capable of toggled translation of all pivoting links to a locked position wherein each respective pair of the first and third axes are proximal each other with the corresponding link blocking clamp member motion, and an unlocked position that enables clamp member pivoting motion about its respective first axis.

19. A remote actuated pivoting clamp mechanism for clamping hot rolling mill cooling line split boxes, comprising:
a plurality of sequentially arrayed split boxes, each having opposed halves defining a path there through and a first engagement surface on at least one of the halves;
a structural member having sequentially arrayed thereon and aligned with each respective split box a plurality of opposed pairs of pivot points respectively sharing a collinear first pivot axis;
a plurality of pairs of elongated clamp members corresponding to each pair of structural member pivot points, each clamp member having an engagement surface proximal one end for mating engagement with a corresponding first engagement surface, a link pivot proximal the other end; and a central pivot intermediate the ends that is pivotally coupled to a respective one of the structural member pivot points about the first axis;
a plurality of pivoting links respectively corresponding to each pair of clamp members, each link having a first end pivotally coupled to both of the clamp member pair respective link pivots about a second collinear axis parallel to the first axis, and a second end; and
an actuator shaft pivotally coupled to each of the respective link second ends about a third axis parallel to the first axis at each respective pair of opposed pivot points, the shaft capable of toggled translation of all respective pivoting links to a locked position wherein each respective pair of first and third axes are proximal each other, with the link blocking respective clamp member motion and maintaining mating engagement between each respective pair of first and clamp member engagement surfaces, and the shaft also capable of translation of all respective pivoting links to an unlocked position that enables clamp member pivoting motion about its respective first axis and disengagement of each mating pair of first and clamp member engagement surfaces.

20. A method for remotely actuating a pivoting clamp mechanism for clamping hot rolling mill cooling line split boxes, the clamp mechanism having:
a plurality of sequentially arrayed split boxes, each having opposed halves defining a path there through and a first engagement surface on at least one of the halves;
a structural member having sequentially arrayed thereon and aligned with each respective split box a plurality of opposed pairs of pivot points respectively sharing a collinear first pivot axis;
a plurality of pairs of elongated clamp members corresponding to each pair of structural member pivot points, each clamp member having an engagement surface proximal one end for mating engagement with a corresponding first engagement surface, a link pivot proximal the other end; and a central pivot intermediate the ends that is pivotally coupled to a respective one of the structural member pivot points about the first axis;
a plurality of pivoting links respectively corresponding to each pair of clamp members, each link having a first end pivotally coupled to both of the clamp member pair respective link pivots about a second collinear axis parallel to the first axis, and a second end;
an actuator shaft pivotally coupled to each of the respective link second ends about a third axis parallel to the first axis at each respective pair of opposed pivot points, the shaft capable of toggled translation of all respective pivoting links to a locked position wherein each respective pair of first and third axes are proximal each other, with the corresponding link blocking respective clamp member motion and maintaining mating engagement between each respective pair of first and clamp member engagement surfaces, and the shaft also capable of translation of all respective pivoting links to an unlocked position that enables clamp member pivoting motion about its first axis and disengagement of each mating pair of first and clamp member engagement surfaces;
an actuator for translating the actuation shaft, coupled thereto; and
a control system, in communication with the actuator, including a controller having: a processor; memory accessible by the processor including therein software that when executed by the processor selectively causes the actuator to translate the actuation shaft; and an interface coupled to the controller, for issuing commands to the translate the actuation shaft;
the method comprising:
issuing a actuator shaft translation command to the control system with the interface; and
executing actuator translation software with the processor, causing the actuator to translate the actuation shaft to the locked or unlocked positions.
